(19) United States
(12) Patent Application Publication
(10) Pub. No.: US 2018/0260820 A1
(43) Pub. Date: Sep. 13, 2018

(54) SYSTEM DEVICE AND PROCESS FOR AN EDUCATIONAL REGULATORY ELECTRONIC TOOL KIT

(71) Applicant: BIOENTERPRISE CORPORATION, Guelph (CA)

(72) Inventors: John Martin KEATING, Guelph (CA); Joel Roberto SOTOMAYOR, Guelph (CA); Mary K. DIMOU, Richmond Hill (CA); Douglas F. KNOX, Stouffville (CA); Laura Elizabeth MILLSON, Rockwood (CA); Emily Katryn HARTWIG, Guelph (CA)

(21) Appl. No.: 15/914,431

(22) Filed: Mar. 7, 2018

Related U.S. Application Data
(63) Continuation of application No. 62/468,015, filed on Mar. 7, 2017.

(51) Int. Cl. G06Q 30/00

(52) U.S. Cl. CPC G06Q 30/018

(57) ABSTRACT

A system and method to automatically identify regulatory requirements for at least one of a product and a service using at least one rule are provided. The system comprises a persistent data store storing the at least one rule relating to regulatory requirements, and a processor. The processor is configured to perform the method. The method comprises receiving at a user interface input data defining at least one of a product and a service, processing the input data using the at least one rule to automatically identify at least one regulatory requirement, receiving compliance data regarding the at least'one of the product and the service, processing the compliance data by automatically evaluating the at least one regulatory requirement, automatically generating and issuing an electronic certificate of compliance for the at least one of the product and the service, and transmitting the electronic certificate. The at least one rule is linked to at least one attribute relating to the at least one of the product and the service.

### FIELD

Embodiments described herein relate to systems and methods of automating the identification, and determination of compliance with, relevant regulatory requirements.

### INTRODUCTION

Regulatory information and the steps required fora fully certified launch of a product or service is often hard to find. The identification of relevant regulatory information can involve multiple searches and extensive research into policies, laws, and regulations issued by multiple governing bodies. The process lacks a cohesive roadmap that identifies every regulatory requirement. In many cases, companies hire regulation consultants to assist with this process, which can be expensive, time consuming, and mistake-prone. Agriculture based companies require assistance in understanding complex regulatory requirements and obtaining certification for launching a specific category or individual sector-related products.

### SUMMARY

Embodiments described herein relate to systems, devices and processes to automatically identify applicable regulatory requirements for one or more products or services with one or more features described herein.

In accordance with an embodiment, there is provide a system to automatically identify regulatory requirements for at least one of a product and a service using at least one rule. The system comprises a persistent data store storing the at least one rule relating to regulatory requirements, and a processor. The processor is configured to receive at a user interface input data defining at least one of a product and a service, process the input data using the at least one rule to automatically identify at least one regulatory requirement, receive compliance data regarding the at least one of the product and the service, process the compliance data by automatically evaluating, the at least one regulatory requirement, automatically generate and issue an electronic certificate of compliance for the at least one of the product and the service, and transmit the electronic certificate. The at least one rule is linked to at least one attribute relating to the at least one of the product and the service.

In accordance with another embodiment, there is provide a system to automatically identify regulatory requirements for at least one of a product and a service using at least one rule. The system comprises a client server for generating and controlling a user interface to receive input data defining at least one of a product and a service, an application server to receive the regulatory compliance request, and a database server to process the regulatory compliance request using rules that define applicable regulatory requirements and automatically generate an electronic certificate of compliance for the at least one of the product and the service in view of regulatory requirements. The client/server generates a regulatory compliance request based on the input data. The client/server is configured to update the user interface to at least one of display and provide the electronic certificate of compliance.

In accordance with another embodiment, there is provide a method of identifying applicable regulatory requirement for at least one product or service using at least one rule. The method comprises receiving at a user interface input data defining at least one product or service, processing the input data using the at least one rule to automatically identify at least one regulatory requirement, receiving compliance data regarding the at least one product or service, processing the compliance data by automatically evaluating the at least one applicable regulatory requirement, automatically generating and issuing an electronic certificate of compliance for the at least one product or service, and transmitting the electronic certificate. The at least one rule is linked to at least one attribute relating to the product or service.

According to an aspect, there is provided a system to automatically identify applicable regulatory requirements for one or more products or services using one or more rules. The system includes a persistent data store storing the one or more rules relating to regulatory requirements. The system includes a processor configured to receive, at a user interface, input data defining one or more products or services. The processor is configured to process the input data using the one or more rules to identify one or more applicable regulatory requirements. The processor is configured to receive compliance data regarding the one or more products and services. The processor is configured to process the compliance data using the one or more applicable regulatory requirements. The processor is configured to issue an electronic statement of compliance for the one or more products and services, and transmit the electronic statement.

According to another aspect, there is provided a system to automatically identify applicable regulatory requirements for one or more products or services using one or more rules. The system includes a client server for generating and controlling a user interface to receive input data defining one or more products or services, the client/server generating a regulatory compliance request based on the input data. The system includes an application server to receive the regulatory compliance request. The system includes a database server to process the regulatory compliance request using rules that define applicable regulatory requirements and automatically generate an electronic certificate of compliance for the one or more products and services in view of the applicable regulatory requirements. The client/server can be configured to dynamically update the user interface to display or provide the electronic certificate of compliance along with one or more metrics mapping the one or more products or services to the applicable regulatory requirements.

### DESCRIPTION OF THE FIGURES

Embodiments will now be described, by way of example only, with reference to the attached figures, wherein in the figures:

FIG. 1 illustrates, in a workflow diagram, an example of a workflow for regulation collection and regulatory assessments.

FIG. 2 illustrates a workflow for performing regulatory assessments and obtaining certification of a product or service.

FIG. 3A illustrates, is a component diagram, an example of a regulatory evaluation system, in accordance with some embodiments

FIG. 3B illustrates, in a flowchart, an example of a method of identifying applicable regulatory requirements for at least one product or service using at least one rule, in accordance with some embodiments.

FIG. 4 illustrates a diagram of an architecture for a system that can generate the specific regulatory requirements applicable to a product with separate services for administrator and user access, according to some embodiments.

FIG. 5 illustrates a diagram of a three-tier architecture for a system that can generate the specific regulatory requirements applicable to a product with separation between a client application layer, service layer, and database layer according to some embodiments.

FIG. 6 illustrates a schematic diagram of a relational database design for a system generating the specific regulatory requirements applicable to a product according to some embodiments.

FIG. 7 illustrates a diagram of another architecture for a system that can generate the specific regulatory requirements applicable to a product according to some embodiments.

FIG. 8 illustrates a diagram of a user interface for providing information to a system that can capture regulatory requirements applicable to a product.

FIG. 9 illustrates a diagram of a user interface for displaying information relating to regulatory requirements applicable to an example product.

FIG. 10 illustrates a diagram of a user interface for registering a user.

FIG. 11 illustrates, in a block diagram, an example of a computing device, according to some embodiments.

### DETAILED DESCRIPTION

Embodiments of methods, systems, and apparatus are described through reference to the drawings.

Embodiments described herein relate to regulatory requirements, regulatory roadmaps defining relationships between regulatory requirements, and regulatory requirements adapted to or reflective of one or more specific regulatory contexts. An example of a regulatory road map can entail the following question and response from the system: “The net quantity of a pre-packaged solid product by weight must be displayed by the product's net quantity weight. Has this information been determined?” If the user responds with a positive response to the question, or a “yes”, the compliance has been met. If the user responds with a negative response to the question, or a “no”, the compliance has not been met and the system will display a regulatory report referencing the regulatory requirement of the question asked. In this specific example, the regulatory reference can be sourced from the following: “Consumer Packaging and Labelling Regulations, Manner of Declaring Net Quantity (22)(1) The declaration of net quantity of a pre-packaged product listed in the table to this subsection can show the net quantity of the product by weight.” This regulatory road map example may be applied to several products as this particular section of the Consumer Packaging and Labelling Regulations pertains to several products including honey, yoghurt, peanut butter etc. A user who is accessing the system to gain knowledge of the regulatory requirements of their specific industry, for example honey, and another user who produces a yoghurt product, will both be directed to the same aforementioned regulatory compliance question by the system. This is a non-limiting example. Regulatory requirements may include information and/or data relating to regulatory requirements, regulatory compliance, regulatory enforcement, and/or certification of a product, service, company, or industry application. Regulatory requirement tokens may include computer representations of one or more regulatory requirements with machine-readable or executable instructions to automatically command a computer to perform specific operations.

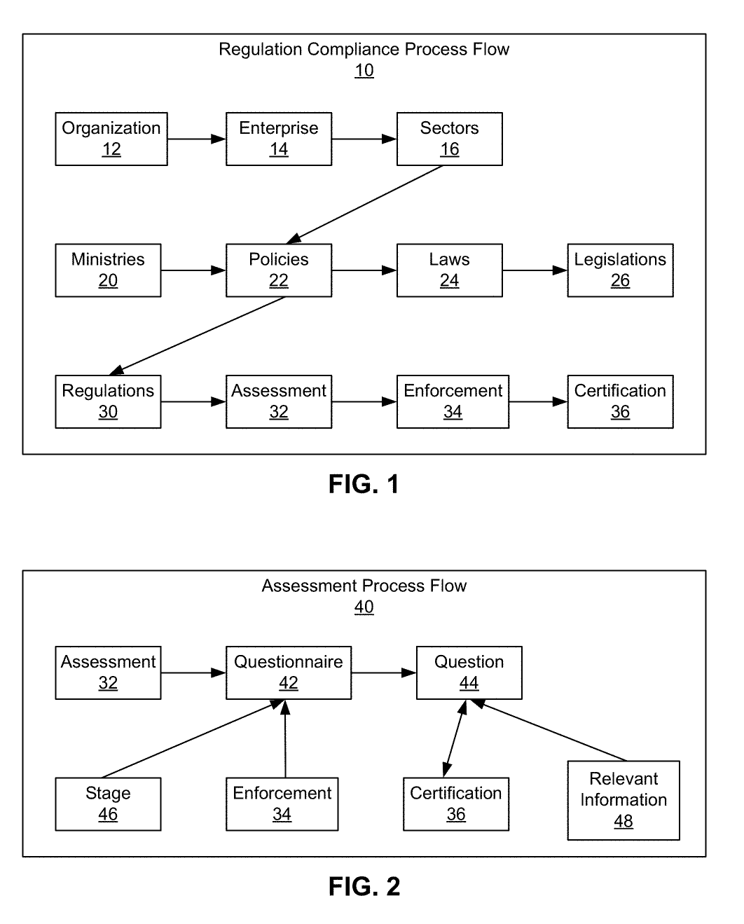

FIG. 1 illustrates, in a workflow diagram, an example of a regulation compliance process flow 10 for regulation collection and regulatory assessments and certification. In processes for management of regulatory requirements, first, a ministry 20 may put policies 22 into circulation. Legislation 26, including laws 24 and regulations 26, may be created from a policy 22 and may be referenced to ensure the enforcement 34 of the regulation 26. A ministry 20 may be able to create policies 22 for multiple industry sectors 16. For example, the Ministry for the Environment may be able to create multiple policies for a number of different industry sectors, and a policy may relate to multiple sectors. One or more organizations 12 may together form an enterprise 14. Organizations 12 and enterprises 14 may be organized by industry sector 16. Products or services may be assessed 32 for their compliance with regulatory requirements, regulations 30 may be enforced 34, and products or services may be certified 36 when they are in satisfactory compliance with regulatory requirements. Each step in this process 10 can be difficult and time-consuming, making the entire process difficult and time-consuming. Example steps include the identification of regulatory requirements that apply to a given product or service from potentially multiple sources and organizational bodies, the assessment 32 of compliance with the regulatory requirements, the enforcement 34 of multiple regulatory requirements for a given product or service, and the certification 36 of a given product or service according to the multiple regulatory requirements.

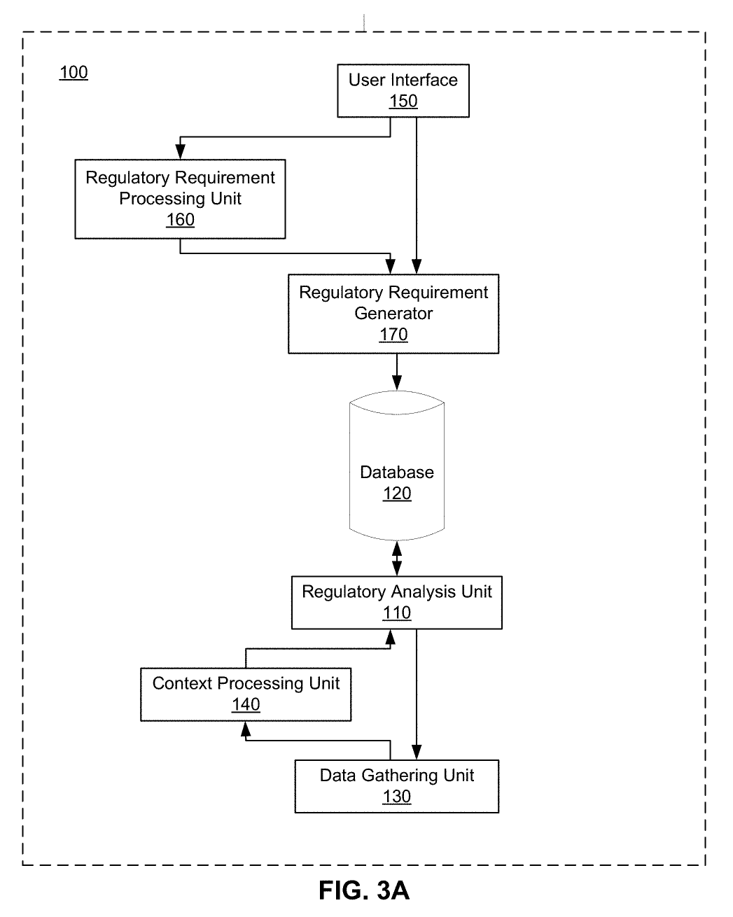

FIG. 2 illustrates in a workflow diagram, an example of an assessment process flow 40 for regulatory certification of a product or service. An assessment 32 may lead to the creation of a questionnaire 42 comprising one or more questions 44. The questionnaire 42 may be used at different stages 46 and for enforcement 34. Answers to questions 44 may involve relevant information 48 and may lead to certification 36.

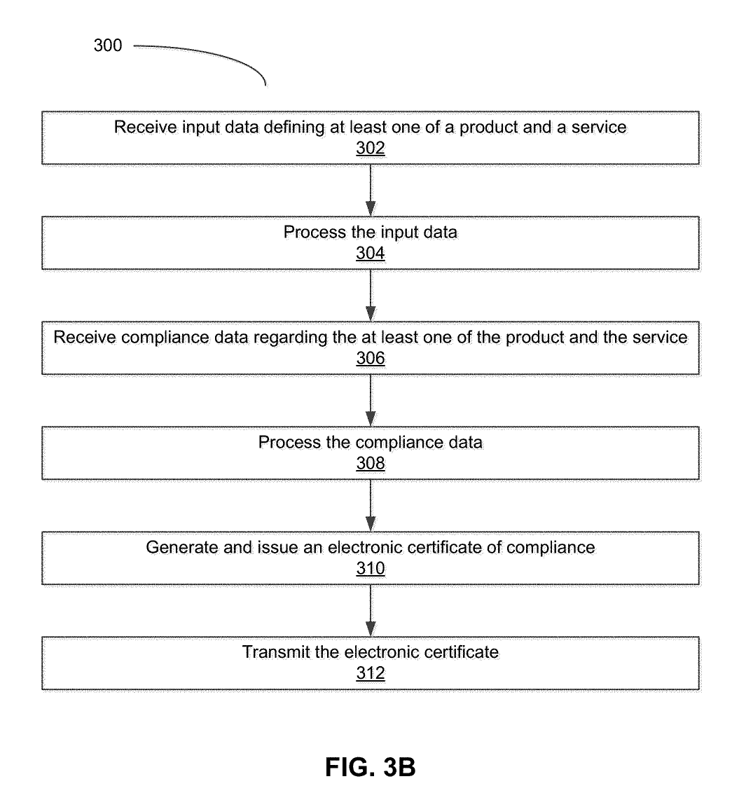

FIG. 3A illustrates, is a component diagram, an example of a regulatory evaluation system 100, in accordance with some embodiments. The regulatory evaluation system 100 may be configured to automatically identify specific regulatory requirements applicable to a product and generate a data set relating to the regulatory requirements, according to some embodiments. The regulatory evaluation system 100 includes a user interface 150, regulatory requirement processing unit 160, regulatory requirement generator 170, a database 120 of rules particular to regulatory requirements, regulatory analysis unit 110, context processing unit 140, and data-gathering unit 130.

The regulatory evaluation system 100 provides at least one specific improvement to computer functionality by automating the identification and assessment of regulatory requirements using particular rules stored in the database 120. For example, a regulatory analysis unit 110 is configured to interact with one or more computer databases 120 and one or more data gathering units 130 to manage and execute different rules in order to automate the identification and assessment of regulatory requirements for particular products and services. The regulatory analysis unit 110 can receive input data defining characteristics of a product or service. The input data can be used to identify a set of rules that apply to characteristics of the product or service. The regulatory analysis unit 110 is configured to construct a regulatory framework for or applying to the given product, service, or context. The regulatory analysis unit 110 is configured to automatically assess compliance of the given product, service or context within the framework using compliance rules. The computer receives data to define a particular product, service, context, user or user device and evaluates one or more criteria associated with a product, service, context, user, user device, and/or data collected from or produced by regulatory evaluation system 100. This may obviate the need for research or regulation consultants to help companies understand the regulatory requirements and certification process for launching a product or service. The structure of the questionnaire 42 can function as a guidance tool to assist the user through the process of the regulatory environment. In some instances, an order of precedence is set in the progression of one question 44 to the next. The sequencing for this process is sourced from the legislation as written.

A user, such as for example, a company or enterprise with user-level access, may provide data to regulatory evaluation system 100 for the generation of a set of one or more regulatory requirements that apply to a product, service, or context. For example, a user engaged with regulatory evaluation system 100 may provide data to or facilitate collection of data by data gathering unit 130, for example, data describing or comprising information relating to a product, service, context, company, enterprise, industry sector, history of engagement with regulatory evaluation system 100, history of compliance with one or more regulatory requirements, history of certification of associated products or services, history of regulatory assessments or results, other relevant information, for example, relating to a clinical trial application or issuance of Natural Product Number (NPN)/Drug Identification Number (DIN), and computer session information. The user may thereby request certification for a product or service in a specified context, identification of applicable regulatory requirements, and/or request a check for compliance with regulatory requirements for a product or service. The regulatory evaluation system 100 is configured to generate or connect with a user interface in order to receive or collect data and commands.

In some embodiments, regulatory evaluation system 100 may not require a programmer or designer to preconfigure a structure to which a user engaged with system 100 must adapt data entry. This may provide an additional specific improvement to computer functionality. For example, regulatory evaluation system 100 via data gathering unit 130 may receive data from a company or enterprise user as natural language input or bulk upload of electronic documentation. Regulatory requirement processing unit 160 may then process and/or apply natural language processing on the input and actuate regulatory analysis unit 110 using one or more rules. In some embodiments, regulatory evaluation system 100 may receive data from a user upon engagement by the user with the regulatory evaluation system 100, without active provision by the user, for example, data relating to the identity or attributes of the user. The user data may be used by regulatory evaluation system 100 to identify other information stored in one or more databases 120 relating to the user, for example, products the user is currently or has previously sought certification for using system 100. In some embodiments, context processing unit 140 may apply one or more natural language processing techniques to data collected by data gathering unit 130 and may use an index or data structure that contains mappings or that enables storage of associations between data input and data tokens. Regulatory analysis unit 110 may use the data tokens relevant from the data input to create one or more strings. Regulatory analysis unit 110 may then use the one or more strings to generate and/or selectively request from one or more databases 120 a regulatory data set of one or more regulatory requirements and/or regulatory tokens selectively identified using the one or more strings. Regulatory analysis unit 110 may thereby generate one or more regulatory pathways, regulatory requirements, regulatory requirement sets, or steps required for certification of a product or service. Each question is paired with a specific regulatory article in the database. A positive answer (e.g., “yes”) elicits and indication of compliance, while a negative answer (e.g., “no”) or a null answer (e.g., “I don't know”) elicits a non-compliance. Regulatory analysis unit 110 is configured to generate a visual representation of the regulatory data and trigger the display and presentation of same at a user interface engaged with system 100.

In some embodiments, as shown in FIG. 3, this may be an iterative process enabling successively generated regulatory pathways to be successively adapted to new data collected from the user. The provision of new data and/or the generation of regulatory pathways may be dynamic, with minimal active engagement by a user with system 100. New data, such as data from responses to each question within the questionnaire for example, updates the regulatory pathway through the indication of compliance or noncompliance. The regulatory evaluation system 100 may thereby support a faster, more accurate, and/or intuitive mechanism for understanding and applying regulatory requirements as they relate to one or more given products. This may be used for facilitating compliance with and/or enforcement of one or more complex regulatory requirements or combination of complex regulatory requirements. For example, as a user product is developed or progresses through satisfaction of regulatory requirements, regulatory evaluation system 100 may automatically receive such updates and generate a new regulatory pathway or set of regulatory requirements that reflects changes to the product or changes to the degree of satisfaction of regulatory requirements.

A database 120 engaged with regulatory evaluation system 100 may store one or more rules for regulatory requirements, regulatory requirement tokens, associations between or amongst regulatory requirements and/or tokens, and/or information relating to same, for example, data defining application or evaluation of regulatory requirements to products, services, and/or contexts. For example, the database 120 may link a set of rules to a particular class of products using a product identifier or class identifier, for example. This may help facilitate the identification of rules relevant to a particular product to be evaluated. This may increase the processing efficiency of system 100 as only a subset of rules are processed during the automatic evaluation of a particular product instead of the entire rule set stored by database 120. Regulatory evaluation system 100 may interact with one or more databases 120 and the rules manage thereby to allow real-time retrieval, storage, and generation of information to be processed using the rules. In some embodiments, data is stored in a database 120 in order to house relational data that may be required for companies to provide required information (i.e., a specific certification). This may allow for real-time data changes and dynamic security. Real-time data changes and dynamic security is managed by the message path within the log-in session. The application server identifies, the item source of the request and connects to the database. Then the database returns the specific element requested. In order to access the user information, the user must log onto the database. The compliance report, returned to the user upon user request, returns information relating to each non-compliance.

In some embodiments, a data gathering unit 130, user interface, and administrator user interface 150 may be available across multi-platform environments, for example, via a mobile application or via a web-based application. The mobile application or web-based application may be accessed by or using any of multiple browsers and any of multiple operating systems. The user interface and administrator user interface 150 may be particular configured for different types of end-user devices, user configurations and processing capabilities.

Administrators may provide data to regulatory evaluation system 100 that may be used by system 100 to define or generate a set of one or more regulatory requirements or regulatory tokens. An administrator engaged with regulatory evaluation system 100 may provide data, for example, describing or comprising a regulatory policy 22, law 24, regulation 30, piece of legislation 26, question 44, or questionnaire 42, to regulatory evaluation system 100 via administrator user interface 150. The data may include unstructured data and structured data. The structured data may include metadata or attributes describing relationships between various data elements and characteristics of data elements for example. The data describing the different regulatory policies can be in machine-readable form or may be transformed by system 100 to be machine-readable. In some embodiments, regulatory evaluation system 100 may not require a programmer or designer to preconfigure a structure to which an administrator engaged with system 100 must adapt data entry for indicating regulatory information. This may provide an additional specific improvement to computer functionality. For example, regulatory evaluation system 100 via administrator user interface 150 may receive data from an administrator as natural language input our bulk upload. Regulatory requirement processing unit 160 may then process and/or apply natural language processing on the input and actuate regulatory requirement generator 170. In some embodiments, regulatory evaluation system 100 may receive data from an administrator upon engagement by the administrator with the regulatory evaluation system 100, without active provision by the administrator, for example, data relating to the identity or attributes of the administrator, which may be used by regulatory evaluation system 100 to identify other information stored in one or more databases 120 relating to the administrator. Policy information is extracted and compiled and then implemented into the database manually by the administrator. All information in the database is organized into specific categories to allow for the information to be fully accessible to the administrator when updates to the information are required. Single data sources from multiple separate categories are selected and then combined to create each question. New or updated policy information, sourced directly from government newsletters and publications, will be implemented manually by the administrator.

Regulatory requirement generator 170 may then generate a set of one or more regulatory requirement tokens from the data received from the user engaged with administrator user interface 150 and/or from the processed data. The one or more regulatory requirement tokens may be combined with one or more other regulatory requirement tokens, used to modify/update/delete/replace one or more other regulatory requirements or regulatory requirement tokens, or used to generate one or more new regulatory requirements or regulatory requirement tokens. For example, if more than one regulatory requirement and/or token relate to each other or would apply to a specific product, a new regulatory requirement and/or token may be created by regulatory requirement generator 170 based on how the more than one regulatory requirements interact. Regulatory requirement generator 170 may store and/or cause to be stored the one or more regulatory requirement tokens and/or the one or more new regulatory requirement tokens. Regulatory requirement generator 170 may modify, update, delete, replace, and/or cause same to occur for one or more regulatory requirement tokens stored in one or more databases 120 associated with regulatory evaluation system 100.

In some embodiments, as shown in FIG. 3, this may be an iterative process enabling regulatory requirement generator 170 to successively modify, update, delete, replace, and/or cause same to occur for one or more regulatory requirement tokens stored in databases 120. The one or more regulatory requirement tokens may together encode regulatory requirements for a specific industry, product, or service. The provision of new data from the administrator, for example, relating to a new law, policy, regulation, legislation, or certification step, and/or modification/update/deletion/replacement of regulatory requirement tokens by regulatory requirement generator 170 may be dynamic, with minimal active engagement by an administrator with system 100. For example, data gathering unit 150 may automatically crawl, index, and/or store regulatory requirement data located on webpages or other resources to facilitate maintenance of system 100 with up-to-date regulatory requirements. The data-gathering unit 150 is configured to automatically detect modifications to stored regulatory data from external sources of regulatory data, and update or modify the stored regulatory data to reflect such modifications. The regulatory evaluation system 100 may thereby support a faster, more accurate, more efficient, and/or more automated mechanism for understanding and applying regulatory requirements as they relate to one or more given products. This may be used for facilitating compliance with and/or enforcement of one or more complex regulatory requirements or combination of complex regulatory requirements. As regulations, their referential links to legislation, and other details may be held in different government and ministry websites, regulatory evaluation system 100 may automatically facilitate the constant administration and update of links and references involved for each product, category of product, and sector based piece of information. Updates to the data store of regulatory requirements will be managed through subscriptions to federal and provincial government change notices. All text and web address information will be manually updated by the administrator.

Regulatory evaluation system 100 may improve the way regulatory information is automatically processed, applied against products and services, enforced against products and services, and identified to be relevant in the context of a particular product and service. For example, regulatory evaluation system 100 may enable the generation of a regulatory framework with fewer computer queries for one or more regulatory requirements or steps leading to certification of a product or service. Regulatory evaluation system 100 may facilitate identification and understanding of one or more regulatory requirements or steps leading to product/service certification. Regulatory evaluation system 100 may reduce or eliminate research required for same, for example, by enabling creation and/or storage of one or more regulatory pathways that may be requested, for example, using natural language input, and returned momentarily. Regulatory evaluation system 100 may additionally dynamically generate the one or more regulatory pathways or requirements for a given product, service, or context, even where the one or more regulatory pathways or requirements for the given product, service, or context has not been previously generated by regulatory evaluation system 100. This may minimize the amount of storage required by a computer managing regulatory requirements that may otherwise store product, service, or context information with specific application of regulatory requirements for each. In one or more of these ways, regulatory evaluation system 100 may enable, expedite, and/or facilitate identification of regulatory requirements for a given product, service, or context; application and/or enforcement of same; and/or understanding of how regulations specifically apply to a given product, service, or context. An example of the regulatory pathway process is the following question posed to a user accessing a questionnaire pertaining to the requirements of a seed trait application: “Has a proposed variety name been established?” In this example scenario, if the user responds with “yes”, that they have in fact developed a proposed variety name for their seed product, the user is in compliance with the specific requirement under the Seeds Regulations 67(1)(a)(i). If the user responds with “no”, the item is in non-compliance, and the requirement details outlined in the Seeds Regulations 67(1)(a)(i) will be displayed for the user's reference. If the user responds with “I don't know”, a non-compliance will be displayed as it would for a “no” answer, in order to provide guidance to the user.

In some embodiments, regulatory evaluation system 100 may provide an integrated method embodied in computer software for use with a computer for the rapid, efficient generation of one or more regulatory requirements or regulatory pathways for a specific product, service, and/or context. This may help avoid a tedious, complicated, time consuming, and potentially inaccurate approach of gathering data from multiple governing bodies, using multiple searches, and/or performing research with no true roadmap available. A “no” response will populate the regulatory requirement pertaining to the specific question asked. These responses return data to the user on the status of the requirement for compliance. A hyperlink path to the requirement is provided to the user for their reference.

In some embodiments, regulatory evaluation system 100 may separate business logic from a user interface 150. For example, the regulatory evaluation system 100 can separate the user interface 150 and the business logic using a service level architecture. This separation may provide further flexibility for development and design.

In some embodiments, regulatory evaluation system 100 may separate access based on user requirements. For example, the regulatory evaluation system can use differential functional requirements of administrators that may provide data to regulatory evaluation system 100 for the generation of a set of one or more regulatory requirements and companies/enterprises that may provide data to regulatory evaluation system 100 for the generation of a set of one or more regulatory requirements that apply to a product, service, or context.

In some embodiments, regulatory evaluation system 100 may control access to its components by authorization of based on credentials (username, password, token). Users may be identified by regulatory evaluation system 100 by one or more user identifiers. Each user may be associated with a user profile that defines one or more access levels to regulatory evaluation system 100. The credentials can be received by way of user interface 150. Through access levels, for example, an administrator access policy and a user access policy includes one or more rules for computer security such as access permissions, flags, and/or hardware and/or software encryption, permitted operations and so on. An access level may define data, features, and/or components of regulatory evaluation system 100 that a user engaged with system 100 via that access level may engage with. For example, a user having administrative access permissions may be able to engage system 100 to cause regulatory requirement processing model 160 and regulatory requirement generator 170 to create regulatory requirement tokens and store same in a database 120, while a user having user access permissions may not. An entity with administrator-level access to regulatory evaluation system 100 may be referred to as an administrator, for example.

An administrator may engage with regulatory evaluation system 100 via an interface 150 that includes one or more form fields for receiving corresponding field values. The field values can define one or more characteristics for product or service for example. The form fields may also include questions for administrator to enter data related to specific sections of various industries. This data may be collected, processed, and stored by regulatory evaluation system 100 through functionality of administrator user interface 150, regulatory requirement processing unit 160, regulatory requirement generator 170, and one or more databases 120 described herein. The one or more databases 120 include rules for processing the form field values. In response to processing received form field values, the regulatory evaluation system 100 is operable to dynamically update the one or more form fields to receive additional data by way of interface 150. For example, regulatory requirement processing unit 160 may apply natural language processing techniques to the data and/or parse the data and associate one or more portions of the data with data tokens in order to understand context and meaning of the received form field values. The regulatory requirement processing unit 160 may trigger identification of one or more additional form fields to receive additional relevant form field values. In some embodiments, regulatory requirement processing unit 160 may associate one or more portions of the data provided by the administrator with one or more data tokens that indicate a question or a questionnaire and a corresponding response. The question can be used to generate or identify relevant metadata to take the corresponding response. The metadata can provide context for the corresponding response. The metadata can identify a user identifier to indicate what user the data was received from.

Regulatory requirement generator 170 may generate one or more query strings from the data tokens to update one or more tables in a database 120 to define and store one or more questions for a specific section of a specific industry and corresponding responses from the data received as form field values. The specific section and/or the specific industry may be specified by the data actively received at interface 150 or may be collected or generated by regulatory evaluation system 100 by virtue of the engagement by the administrator with the system 100. For example, regulatory evaluation system 100 may collect login or credential details, identify one or more identifiers for the administrator, and associate the session with existing data stored in a database 120 that relates to the particular administrator. The existing data may include a specific section or specific industry that the administrator governs or creates regulations for. The existing data may identify one or more product or services relevant to the particular administrator.

In some embodiments, regulatory requirement processing unit 160 may associate one or more portions of the data provided by the administrator with one or more data tokens that indicate one or more regulatory requirements. That is, one or more data tokens can define data specifying or characterizing one or more regulatory requirements. Regulatory requirement generator 170 may then generate one or more query strings from the data tokens to update one or more tables in a database 120 to define and store one or more regulatory requirements.

Entities with user-level access, such as for example, companies or enterprises, may engage with regulatory evaluation system 100 to extrapolate data or transform data provided by an administrator. For example, the entity may request an assessment of their specific product, service, context, or industry and/or certification of same. Regulatory evaluation system 100 may then present the entity with one or more questions or a questionnaire by way of a form field at interface 150 requesting information that may be used by regulatory evaluation system 100 to assess the stage of compliance with regulatory requirements for the specific product, service, context, or industry. Regulatory evaluation system 100 may store the information and issue one or more certifications for the specific product or service based on the answers and status of the questionnaires filled by a user, for example, from a pre-defined set of required results or from a set of required results generated by regulatory analysis unit 110. Regulatory evaluation system 100 may accomplish this through functionality of data gathering unit 130 and context processing unit, which may apply natural language processing techniques to the answers supplied by the entity, associate data tokens with portions of the answers, generate one or more strings from the data tokens to query one or more databases 120, similarly to a process described herein. Regulatory evaluation system 100 may thereby automatically assess the stage of compliance of the product or service with one more regulatory requirements or complex regulatory pathways based on answers provided by the entity. The entity may save assessments, which database 120 may then associate with other information related to the entity, and the assessments may then be retrieved later only by the entity based on access permissions stored in one or more databases 120.

In some embodiments, the assessment process leads towards the generation by regulatory analysis unit 110 of information on laws and legislations that are required to be followed for a specified product or service in order to achieve and mark a new product launch as being certified. The information may be supplied or elicited from a user as a workbook or questionnaire they need to complete. In some embodiments, engagement with regulatory evaluation system 100 may be solely at the discretion of a user to complete and on completion of all required questions and relevant data, the user itself may be in charge of changing the assessment status to certify. In some cases, regulatory analysis unit 110 may provide an opportunity for a third-party or additional user to review or modify information related to certification of a product or service. Regulatory analysis unit 110 may correspondingly cause the change to be reflected in one or more databases 120.

As a further example of engagement by an entity with user-level access, the entity may request regulatory requirements for a specific product, service, context, or industry and regulatory evaluation system 100 may generate regulatory requirements or a regulatory pathway outlining steps that the entity must follow in order to obtain certification for the specific product, service, context, or industry. Regulatory evaluation system 100 may automate the gathering of the regulations required for completion to certification level via the use of pre-defined roadmaps (workbooks) or questionnaires or via regulatory requirements granted by regulatory analysis unit 110 and may feed to the entity, via an interactive report, all regulations or regulatory requirements that must be fulfilled in order for regulatory compliance to be resolved as well as all helpful link information regarding each of these steps or regulations. Regulatory evaluation system 100 may also indicate to the entity what stage they appear to be in the process based on answers supplied by the entity.

In some embodiments, an administrator may have limited permitted operations such as for example, inputting data to the system 100. The system 100 can populate user interface 150 with data in a secured manner based on access permissions so that depending on the type of data, only the data with specific user permissions granted can be viewed, updated, deleted, or modified based on its type. Regulatory evaluation system 100 may allow an administrator to specify user permissions for each type of data and/or particular data. Regulatory evaluation system 100 may record and/or implement the user permissions by engaging security features, access permissions, flags, and/or hardware and/or software encryption and associating same to the data.

In some embodiments, an administrator may engage with regulatory evaluation system 100, for example, via a web application providing user interface 150, to create, delete, update, and/or modify information or data stored, collected, requested, and/or maintained by regulatory evaluation system 100 and/or information available to users on an ongoing basis. This may be enabled via a secure connection accessible only to the administrator user interface 150.

In some embodiments, regulatory evaluation system 100 may include a an authorization unit that may capture data relating to changes or modifications by an administrator of data stored, collected, requested, and/or maintained by regulatory evaluation system 100. For example, system 100 can generate an audit trail that records holds a log of when, by who, and what data was updated, deleted, or modified. This may provide system stability and regression support.

Companies, enterprises, or individuals may benefit from regulatory evaluation system 100 on user-level access in order to understand regulatory requirements for particular products and services. In some embodiments, user-level access may enable electronic interaction with regulatory evaluation system 100 through sign-up capabilities, user-specific data storage, permission based data access, and data provision. System 100 can implement data isolation security measures to segregate data for particular users. This may increase security as data is not co-mingled for particular users and is physically separate from data for other users.

Authorization capabilities may include an ability to sign up and request access to regulatory evaluation system 100 based on the specific enterprise or company a user works for. Regulatory evaluation system 100 may dynamically monitor a sign-up process or request a sign-up process in order to ensure user accounts are valid and subscriptions have been catered for. Regulatory evaluation system 100 may collect information from the user with minimal active user input, for example, information by virtue of the engagement by the user with system 100.

User specific data storage may include an ability for a user to store complete and incomplete information related directly to the user's specific user login. For example, multiple pieces of information in process at the same time at many different statuses may be managed by regulatory evaluation system 100 and stored in one or more databases 120 based on a unique identification keyword (e.g., product name, type, category).

In some embodiments, a user may only be able to provide information related to the user's access permissions. For example, the access permissions may be linked to an industry sector that the user's employer belongs to. Permission based data access may limit a user engaged with regulatory evaluation system 100 from engaging with, viewing, and/or modifying certain data, such as for example data linked to other users. Regulatory evaluation system 100 may implement permission based data access using security features, access permissions, flags, and/or hardware and/or software encryption. Regulatory evaluation system 100 may filter data stored by regulatory evaluation system 100, for example, regulations and regulatory requirement tokens, according to access permissions associated with the data and/or associated with the user. Only filtered data may be presented by regulatory evaluation system 100 to the user. Regulatory evaluation system 100 may associate a filtering scheme with an individual user and store the association in one or more databases 120. This may improve the speed by which a user may be presented with and/or engaged with data the user has access to and may provide a more secure data storage system through compartmentalized data structuring. In some embodiments, data that a user or a category of users has access to may be stored in separate databases 120, separate physical computing devices, and/or logically separate data structures, thereby facilitating the security of data and helping ensure that a user may only engage with, modify, and/or be presented with data that the user has access to according to access permissions stored, managed, and/or enforced by regulatory evaluation system 100.

FIG. 3B illustrates, in a flowchart, an example of a method 300 of identifying applicable regulatory requirements for at least one product or service using at least one rule, in accordance with some embodiments. The method 300 may be performed by the regulatory evaluation system 100. The method 300 comprises receiving 302; at a user interface, input data defining at least one product or service. Next, the system 100 may process 304 the input data using the at least one rule to automatically identify at least one regulatory requirement. The rules may be linked to at least one attribute relating to the product or service. In some embodiments, processing the input data comprises obtaining a set of at least one regulatory requirement attribute associated with the input data. Next, the system 100 may receive 306 compliance data regarding the at least one of the product and the service. Next, the system 100 may process 308 the compliance data by automatically evaluating the at least one applicable regulatory requirement. In some embodiments, processing the compliance data comprises comparing the compliance data with the set of at least one regulatory requirement attribute. Compliance may be determined when there is a match between the compliance data and the at least one regulatory requirement attribute. Noncompliance may be determined when there is not a match between the compliance data and the at least one regulatory requirement attribute. Next, the system 100 may automatically generate and issue 310 an electronic certificate of compliance for the at least one product or service. In some embodiments, automatically generating and issuing an electronic certificate of compliance may comprise, upon determining compliance, generating an electronic certificate of compliance for the at least one of the product and the service, and electronically transmitting the electronic certificate of compliance. In some embodiments, automatically generating and issuing an electronic certificate of compliance may comprise, upon determining noncompliance, generating a message of noncompliance for the at least one of the product and the service, and electronically transmitting the message of noncompliance. Next, the system 100 may transmit 312 the electronic certificate. Examples of transmitting the electronic certificate include displaying the electronic certificate on a display screen of the system 100, or sending an electronic message or document to a user of the system 100. Other steps may be added to the method 300.

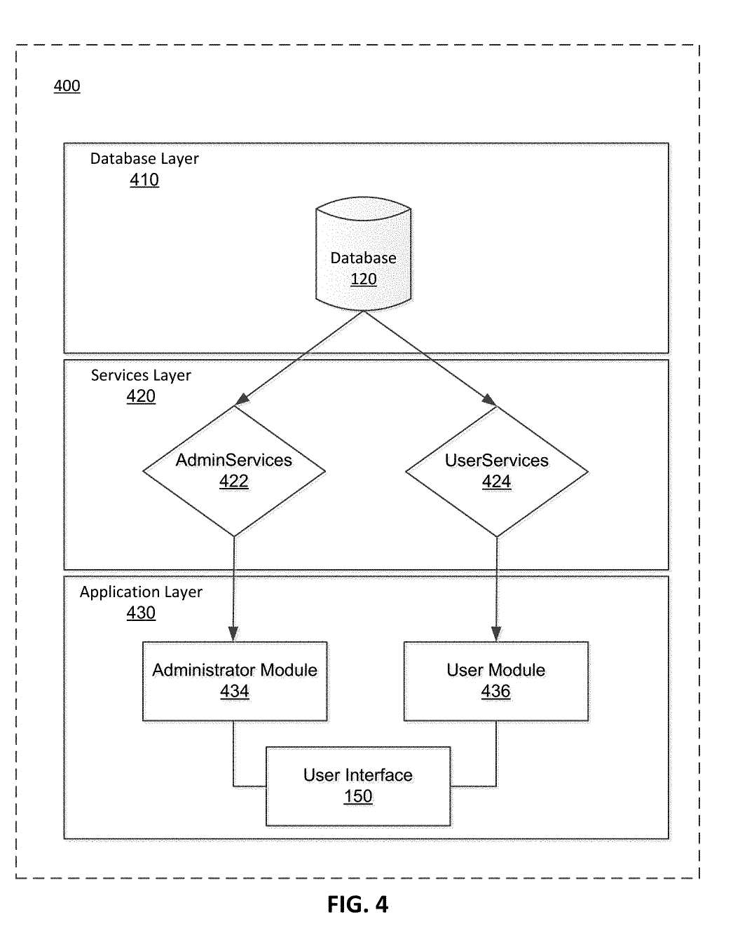

FIG. 4 is a diagram of an example system architecture 400 that may be used to implement aspects of system 100. As shown, the system architecture 400 includes a database layer 410, a services layer 420, and an application layer 430. The database layer 410 includes one or more databases 120 of rules to automate the regulatory process implemented by regulatory evaluation system 100. The services layer 420 implements one or more administrative services and one or more user services. The application layer 430 implements one or more user interfaces 150. Example user interfaces 150 include a user interface for an administrator and a user interface for a user.

The system architecture 400 may facilitate security of data and help ensure that a user or administrator may only engage with data that the user has access to. Security of data may be managed by separation of services, for example, with a dedicated service for administrator-access level 422, 434 and a dedicated service for user-access level 424, 436. An entity with administrator-access privileges may engage with data stored or managed by regulatory evaluation system 100 via an administrator service 422, and an entity with user-access privileges may engage with data stored or managed by regulatory evaluation system 100 via a user service 424. The entity may not engage with any data not marked by regulatory evaluation system 100 as accessible to the entity.

For example, a user may be able to create new or update existing data, such as for example, answers to one or more questions 44 or questionnaires 42, related to a specific keyword, for example, indicating a product, category, or industry, that is related to the user's or the user's company's role within the agricultural industry. The user may input unstructured or structured data of one or more keywords, for example, a product name. The user interface 150 may provide data for the keywords to regulatory evaluation system 100 via data gathering unit 130. Context processing unit 140 may obtain additional information from the user without the user actively supplying the information, for example, by virtue of the nature of engagement by the user with regulatory evaluation system 100 or login information associated with the user. Context processing unit 140 may associate additional information with the user or the current engagement by the user with the regulatory evaluation system 100, for example, by requesting additional data from one or more databases 120 that is associated with data collected from the user.

Context processing unit 140 may then process the product name, for example, using the processes described herein such as natural language processing techniques, and regulatory analysis unit 110 may generate a set of questions or a questionnaire indicating the information that must be supplied to check compliance with relevant regulatory requirements and/or steps that the user or the users company must complete to achieve certification of the product. The set of questions or the questionnaire may be generated by regulatory evaluation system 100 using the processes described herein, for example, by filtering stored data to obtain an exact set of data responses required or by selectively requesting from one or more databases 120 a set comprising one or more regulatory requirements and/or regulatory tokens selectively identified using one or more strings. Regulatory analysis unit 110 may thereby generate one or more sets of regulatory requirements, regulatory pathways, regulatory requirements, regulatory requirement sets, or steps required for certification of a product or service, where the generated regulatory information is tailored to the indicated product. If the user requested information on the regulatory requirements required for certification of the indicated product, this generated regulatory information may be presented to the user by way of interface 150 for example. Regulatory analysis unit 110 is operable to transform the regulatory information to generate different visual representations of the regulatory information for display a user interface 150. The interface 150 can receive commands to dynamically update the display of the regulatory information.

In some embodiments, when information additional to the product name is required, for example, when the user requests assessment of its product's compliance with the regulatory requirements, the user may instead be presented with the set of questions or the questionnaire that is tailored to eliciting the information necessary to perform an assessment of regulatory compliance for the specified product. The data gathering unit 130 may collect the user's provided answers to the questions. This data may be associated with or combined with additional data from context processing unit 140, and regulatory analysis unit 110 may generate or cause to be generated one or more regulatory pathways, regulatory requirements, regulatory requirement sets, steps required for certification of a product or service, information about the stage the product assessment has been completed to by the user or the user's company, information indicating grant of certification for the user's product, and/or associated information, depending on what has been requested by the user. For example, where the user requested assessment of its product's compliance with the regulatory requirements, regulatory analysis unit 110 may automatically assess the stage of compliance with the appropriate regulatory requirements as described herein. Regulatory evaluation system 100 may then present results of the assessment to the user.

In some embodiments, a user engaged with regulatory evaluation system 100 can transmit one or more requests for an assessment of a provided product's or service's compliance with regulatory requirements. The request can include a user identifier along with data defining one or more attributes of the product or service.

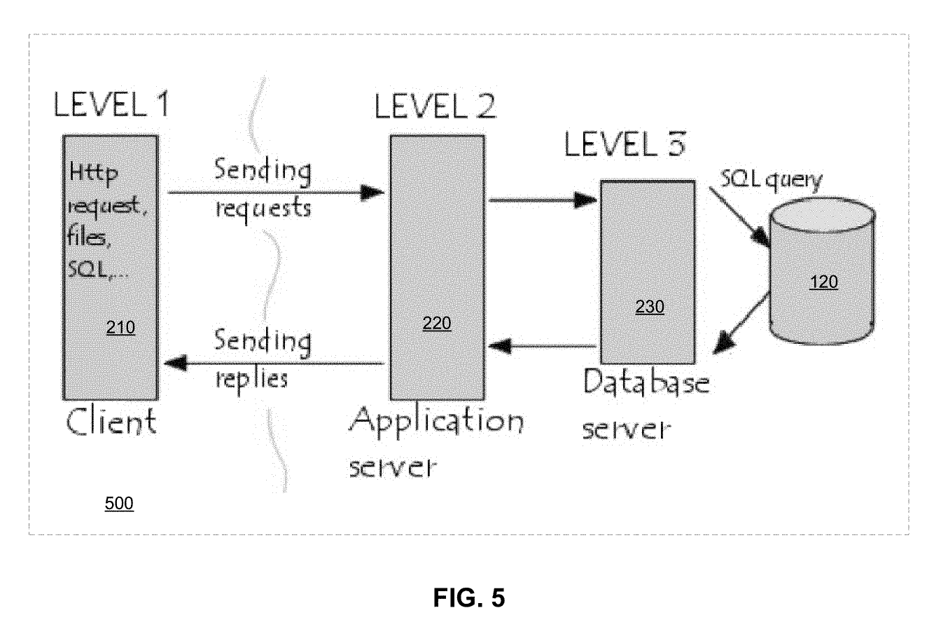

In some embodiments, regulatory evaluation system 100 may be implemented using a 3-tier architecture, including a database back-end, middle tier layer, and a web-based user interface. FIG. 5 is a diagram of an example 3-tier architecture 500. Level 1 may be a client tier 210, for example, a web-based application that sends requests to and receives replies from level 2 application server 220 and user interface 150 at client device. For example, a request may be initiated by an administrator to create a regulation or a questionnaire for a specified industry sector or may be initiated by an entity with user-level access permissions to obtain regulatory requirements concerning a specified product, to obtain regulatory certification for a specified product, or to identify the stage at which a specified product is in for its regulatory pathway to certification. Application server 220 may send requests to and receive replies from level 3 database server 230. Database server 230 may process one or more requests and generate one or more query strings, for example, SQL queries, and use same to update, modify, delete, and/or retrieve data and/or tables in one or more databases 120. Regulatory evaluation system 100 may be based on .Net technology standard 3-tier enterprise architecture.

A regulatory evaluation system 100 implementing this design may be advantageous for separating business logic from client 210 and may enforce data integrity security on the database.

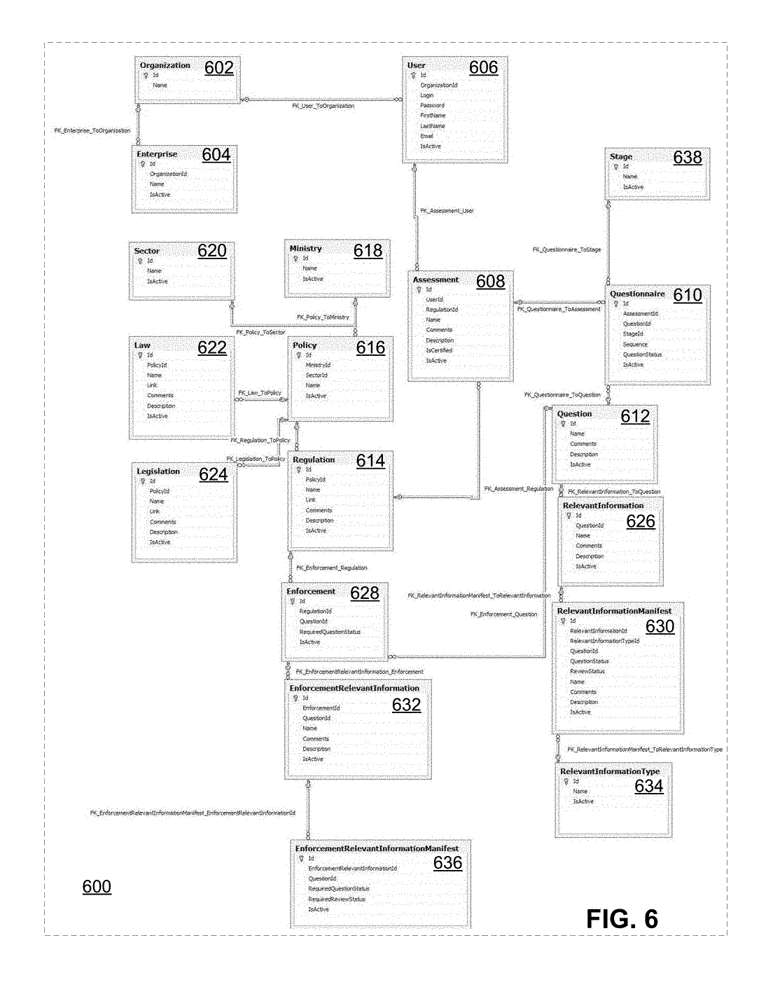

In some embodiments, a regulatory evaluation system 100 may include one or more databases 120 implementing a relational database model 600. FIG. 6 is a diagram of an example database model 600 that may facilitate referential integrity and functionality and automates operation of regulatory evaluation system 100. The database model 600 includes one or more database tables or data records. A table is a data structure that defines a set of data elements (values) and corresponding data types. A table is used to define the structure of different instances of data elements for different classes of data. A table can include data elements that link or reference a data element of another table to provide relational connections between tables. A table can include data elements that uniquely identifies the instance of the table. The database model 600 can define data stored by the one or more databases 120. The tables may include organization table 602, enterprise table 604, and a user table 606. The tables may include an assessment table 608 a questionnaire table 610, a question table 612, a regulation table 614, a policy table 616, ministry table 618, a sector table 620, a lot table 622, a legislation table 624. The question table 612 may link to a relevant information table 626 which in turn links to a relevant information manifests table 630 and a relevant information type table 634. The tables may include an enforcement table 628 which in turn links to enforcement relevant in for table 632 and enforcement relevant information manifests table 636. The questionnaire table 610 may link to a stage table 638.

Each table may include one or more data elements are data fields to define attributes and store information and relationships. Different tables or data records may be linked by different keys or data values.

An organization may be a .body that has a collection of enterprises associated with it (e.g., BioEnterprise, Soy 20/20). An enterprise may be a company or entity that consists of users. These users may access the regulatory enforcement system 100 as a knowledge base to complete compliance of regulations and attain compliance certification. The organization table 602 can include data elements such as the organization name, and an organization identifier. The user table 606 can include data elements such as a user identifier, an organization identifier, login credentials, password, first name, last name, email address, active state, and so on. The user table 606 can link to the organization table 602 by way of an organization identifier, for example. The enterprise table 604 can include data elements such as enterprise identifier, organization identifier, enterprise name, active state, and so on. The enterprise table 604 can link to the organization table 602 by way of an organization identifier, for example.

User can interact with regulatory evaluation system 100 to initiate an assessment for a particular product or service. The assessment table 608 can include data elements such as an assessment identifier, a user identifier, a regulation identifier, assessment name, comments, description, certification status, active status, and so on. The regulatory evaluation system 100 creates a new assessment instance modelled based on the assessment table 608 to assess a product or service for a user. The assessment table 608 and instances thereof can link to a user table and instances thereof by way of a user identifier, for example. The assessment table 608 and instances thereof can link to a regulation table 614 by way of a regulation identifier, for example.

The database model 600 manages data relating to regulations using the regulation table 614 the policy table 616 the ministry table 618, the sector table 620, the law table 622, and the legislation table 624. Examples of industry sectors may be food, nutraceuticals, and cosmetics. An enterprise may be involved in more than one sector of industry. A ministry may be a government department. A ministry may be in charge of policy creation. For example, an entity engaged with regulatory evaluation system 100 that represents a ministry may be assigned administrator-level access permissions by regulatory evaluation system 100 and interact with system 100 using a particular user interface 150 configured for the ministry based on a ministry profile, for example. A policy may be a course or principle of action adopted or proposed by a ministry. There may be multiple policies per ministry related to multiple industry sectors. Policies may be federal or provincial. A law may be a system of rules related to a one or a number of policies are required to be enforced. There may be multiple laws per policy. Legislation may be one or more laws considered collectively. A regulation may be a directive made and maintained by an authority to enforce the laws and legislation of the policy it pertains to. There may be multiple regulations per policy.

The regulation table 614 can include data elements such as a regulation identifier, a policy identifier, a regulation name, a regulation universal resource locator or link, comments, description, active status, and so on. A regulation table 614 and instances thereof can link to a policy table 616 and instances thereof by way of a policy identifier. A policy table 616 can include data elements such as a policy identifier, a ministry identifier, a sector identifier, a policy name, an active status, and so on. A policy table 616 and instances thereof can link to a ministry table 618 and instances thereof by way of a ministry identifier. A policy table 616 and instances thereof can link to a sector table 620 and instances thereof by way of a sector identifier. A ministry table 618 can include data elements such as a ministry identifier, a ministry name, an active status, and so on. A sector table 620 can include data elements such as a sector identifier, sector name, an active status, and so on. The law table 622 can include data elements such as a law identifier, a policy identifier, a law name, a universal resource locator or link, comments, description, active status, and so on. A lot table 622 and instances, thereof can link to a policy table 616 by way of a policy identifier, for example. The legislation table 624 data elements such as legislation identifier, policy identifier, legislation name, universal resource locator or link, comments, description, active status, and so on. The legislation table 624 and instances thereof can link to the policy table 616 and instances thereof by way of a policy identifier, for example.

An assessment may be an assessment of compliance of a product or service to a policy and its regulations in order to gain certification. An assessment may consist of multiple questions or a questionnaire that may be related to a regulation and may also consists of a stage to identify at what stage the assessment has been completed to, for example, for a given product or service. A questionnaire may be a collection of questions related to an assessment that may appear on-screen and require input from a user, for example, natural language, selection of one or more responses, or ticking off items as completed. A question may be a succinct fact that needs to be answered by a user in order to conform to compliance. A question may be part of a questionnaire but in order to be able to be reused for more than one product, service, industry, company, or context, for example, a question may be related to multiple questionnaires. A question may also consist of a subset of data called relevant information. Relevant information may be related to data such as supporting documents, for example, issuance of NPN/DIN or clinical trial application. A stage may be a specific value that may be assigned to a question in order for it to appear in a specific part of a questionnaire, for example, Product Concept, Research, Development, all the way through to International Markets. An assessment table 608 and instances thereof can link to a questionnaire table 610 and instances thereof by way of an assessment identifier, for example. Questionnaire table 610 elements such as a questionnaire identifier, and assessment identifier, one or more question identifiers, a stage identifier, sequence, question status, active status, and so on. A stage table 638 can include data elements such as a stage identifier, a stage name, an active status, and so on. Question table 612 can include data elements such as a question identifier, a question name, comments, description, active status, and so on. The question table 612 and instances thereof can link to the questionnaire table 610 and instances thereof by way of a question identifier. Relevant information table 626 can include data elements such as relevant information identifier, question identifier, relevant information name, comments, description, active status, and so on. Relevant information manifest table 630 can include data elements such as relevant information manifest identifier, relevant information identifier, relevant information type identifier, question ID, question status, review status, manifest name, comments, description, active status, and so on. Relevant information type table 634 can include data elements such as relevant information type identifier, relevant information type name, active status, and so on. The question table 612 and instances thereof can link to the relevant information table 626 and instances thereof by way of a question identifier. Relevant information manifest table 630 and instances thereof can link to relevant information table 626 and instances thereof by way of relevant information identifier for example. The relevant information type table 634 and instances thereof can link to the relevant information manifest table 630 and instances thereof by way of a relevant information type identifier, for example. The relevant information manifest table 630 and instances thereof can link to the question table 612 and instances thereof by way of a question identifier, for example.

An assessment may also have an enforcement template that states what each stage, answer, question, or other data provided by a user in relation to a product or service may look like in order for certification or a stage leading to certification to be been achieved. There may be only one enforcement and questionnaire per assessment. The enforcement table 628 can include data elements such as enforcement identifier, regulation identifier, question identifier, required question status, active status, and so on. The enforcement relevant information table 632 can include data elements such as enforcement relevant information identifier, enforcement identifier, question identifier, enforcement relevant in name, comments, description, active status, and so on. The enforcement relevant information manifest table 636 can include data elements such as an enforcement relevant information manifest identifier, enforcement relevant information identifier, question identifier, required question status, required review status, active status, and so on. The enforcement table 628 in instances thereof can link to the question table 612 and instances thereof by way of a question identifier, for example. The enforcement table 628 and instances thereof can link to the enforcement relevant in table 632 and instances thereof by way of an enforcement identifier, for example. The enforcement relevant in an table 632 and instances thereof can link to the enforcement relevant information manifest table 636 and instances thereof by way of a enforcement relevant information identifier, for example.

Enforcement may be a workflow from which a regulation becomes considered completed. The enforcement may consist of a template decision tree or questionnaire created by an administrator within an administrative tool provided by regulatory evaluation system 100 and associated to regulations of a policy. When questionnaire data is considered to have completed the enforcement, for example, both match, certification may then be granted. Enforcement may relate one to one with an assessment. Compliance may be the end status being sought on completion of a questionnaire or a workbook. The workbook can be a sector-specific guidance document, designed to provide the user with a general understanding of the regulatory environment. The workbook provides educational material to educate the user on the structure of the regulatory environment, provide an indication of the question structure in the system, and act as a reference resource to guide the user as they work through the system's compliance questionnaires. On a match between enforcement and a questionnaire, the questionnaire may be updated in a database 120 to have a status of compliant.

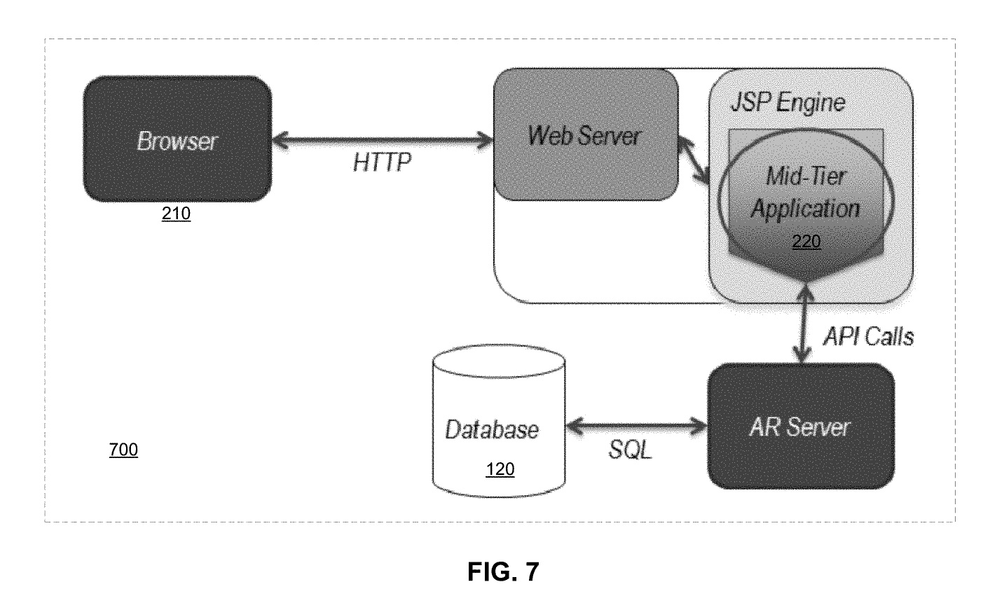

FIG. 7 is a diagram of an example architecture 700 of regulatory evaluation system 100. The architecture 700 includes a browser 210 that connects to a middle layer having a web server 702, JavaServer Pages (JSP) engine 704 and a middle tier application 220. The middle tier application 220 exchanges application programming interface (API) calls with an AR server 706 which in turn makes data base queries to database 120 to receive data stored therein. The browser 210 can include user interface 150, web client or client application, for example. Middle tier layer 220 may be a service layer that communicates with one or more databases 120 and with the browser 210. Middle tier application 220 may facilitate transmission of and/or process information between a browser 210 and one or more databases 120 using modelled data. The questionnaire query elicits the regulatory compliance narrative with a description of the requirement and a web link to the regulation. Each questionnaire article response will engage a response from the system to present the established data, located on the database, and return the data to the user. This architecture 700 may provide robust support of regulatory evaluation system 100 with business logic that is not tightly attached to the browser 210 or interface 150, allowing for other applications and other future interfaces to use the services provided by regulatory evaluation system 100. This architecture 700 can be used also across multi-platform environments. The architecture 700 implements data security using service accounts, where entities engaged with regulatory evaluation system 100 may only see the data supplied via the service provided to it. The architecture 700 processes and handles operations involving one or more databases 120 and other reporting functions outside of the client application at browser 210 which can allow for better performance for web users. The architecture 700 improves data integrity and error handling. User level permissions can be built into stored procedures and the user information is sent by a service call from the website to the filtered data, for example a list of assessments available per user. Two services can separate the functionality, User Services and Administrative Services in order to ensure that the administrative capabilities are not accessible to a non-administrative user. The architecture 700 allows for distribution of services to another sewer if required.

In some embodiments, the following architecture may provide added security to regulatory evaluation system 100. For example, a service layer can be setup to use an NT Service Account and permissions are granted as required per service to each database table or stored procedure. As another example, calls to databases 120 can only to stored procedures, never directly to tables. This can be for security and safety purposes. As an additional example, user level permissions can be built in to stored procedures and user information can be sent with service calls from a browser 210 interacting with the user device to filter data. The information may include a list of assessments available per user or per enterprise of the user and whether the entity engaged with regulatory evaluating system 100 is an enterprise user, a company user, or an administrator. In some embodiments, only saved assessments can be shown in the browser 210. In some embodiments, two services, User Services and Administrator Services, are used to separate functionality. In this way, administrative capabilities will never be available to non-administrative users.

In some embodiments, client application at browser 210 may be separated into application units for each user-access level, for example, for entities with user-level access permissions and for entities with administrator-level access permissions. This may further provide security to regulatory enforcement system 100. For example, on login by an entity to regulatory enforcement system 100, based on the credentials received back on validation by the system 100, the entity will be redirected to the unit corresponding to their access-level permissions. This may provide regulatory evaluation system 100 with two separate navigation menus and segregation of data provision to system 100 into two separate areas. This may also allow for separate web applications to be created and worked either in tandem or in sequence, easing deployment and future change requests. Each application unit may also connect to its own dedicated service layer, as illustrated in FIG. 4.

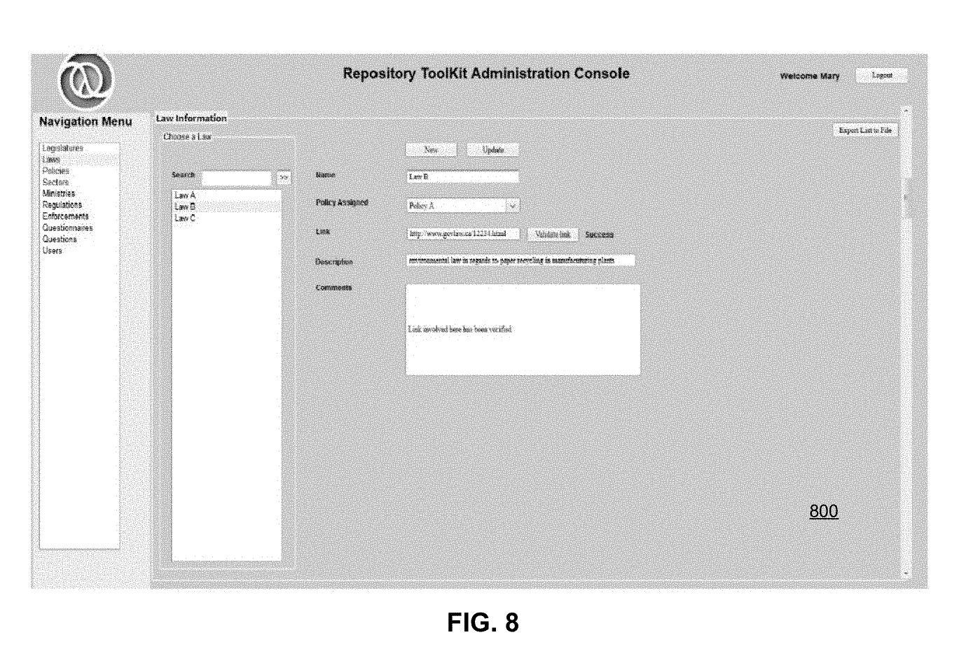

There may be provided a user unit and an administrator unit. A detailed compliance report detailing the requirements the user has yet to meet is created as the user responds to each question. Once the user has provided a response for each question, the compliance report is available for review. FIG. 8 is a diagram of an example administrator user interface 800 of a browser 210 (web client, client application) used by an administrator to exchange data with regulatory evaluation system 100. For example, the administrator user interface 800 may include a dynamic navigation bar 802 that may, based on user permissions of the entity engaged with system 100, show a list of possible data that may be viewed, updated, or created. For example, the Ministry of the Environment may provide administrator user interface 800 with login credentials linked to the Ministry. In some embodiments, regulatory evaluation system 100 may identify and/or receive the credential information and other information associated with the engagement by the Ministry with the system 100, regulatory evaluation system 100 may retrieve related information from one or more databases 120 based on that information and may process, calculate, and/or generate additional information based on same, and regulatory evaluation system 100 may populate the navigation bar 802 with categories of data that may be accessed or modified by the Ministry based on the information retrieved, received, processed, and/or generated by regulation evaluation system 100. For example, regulatory evaluation system 100 may store data indicating that the Ministry of the Environment only has access to environment-related laws, policies, and industry sectors. In such case, the administrator unit 150 may only display information flagged in database 120 or retrievable from database 120 as relating to same.

In some embodiments, client application 210 may be divided into three principal sections: a section for introduction to regulations by sector and specific sub-sectors, workbook section to reveal specific regulatory requirements for a product, service, or context, and a questionnaire section to determine a product compliance with the appropriate regulations within the applicable sectors.

Access levels to client application 210 and/or components of or data within regulation evaluation system 100 may be customized by certain users, for example, users with administrative-level access permissions. This may enable subscription access to regulatory information and workbooks and compliance assessments by payment of fee specific to product regulatory sector. For example, organizations may be granted access permissions enabling them to customize access to client application 210 and/or components of or data within regulation evaluation system 100 within that organization's industry sector.

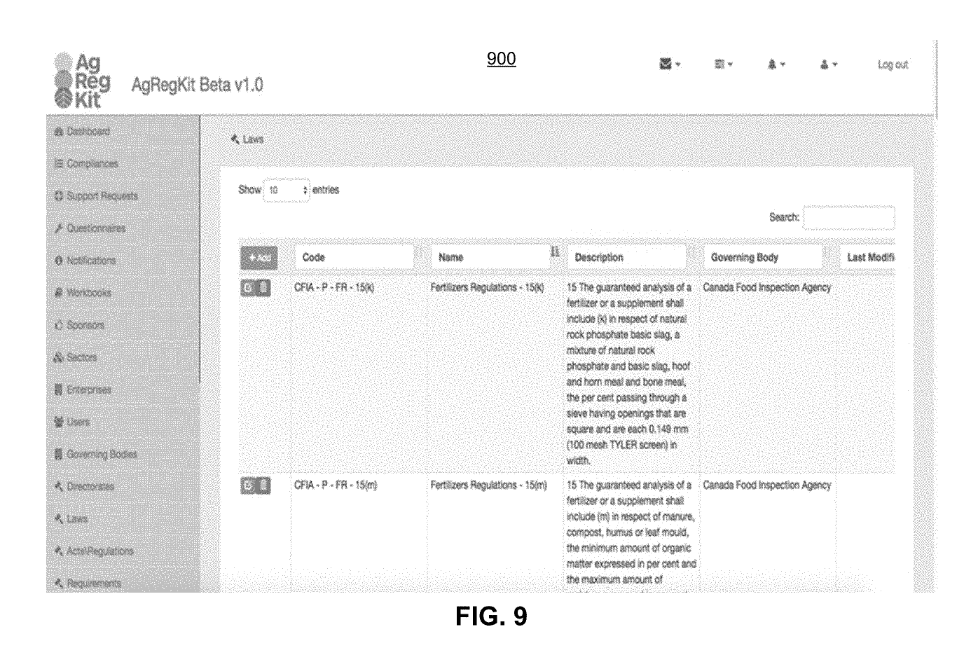

FIG. 9 illustrates a diagram of a user interface 900 for displaying information relating to regulatory requirements applicable to an example product. The interface 900 may be part of a browser 210 (web client, client application) or user interface 150 in order to exchange data with regulatory evaluation system 100. For example, the interface 900 may receive data of attributes relating to a product, such as fertilizer, for example. The interface 900 may display a dynamically generated list of regulations relating to the product. The interface 900 can receive commands to view or modify the attributes or regulations.

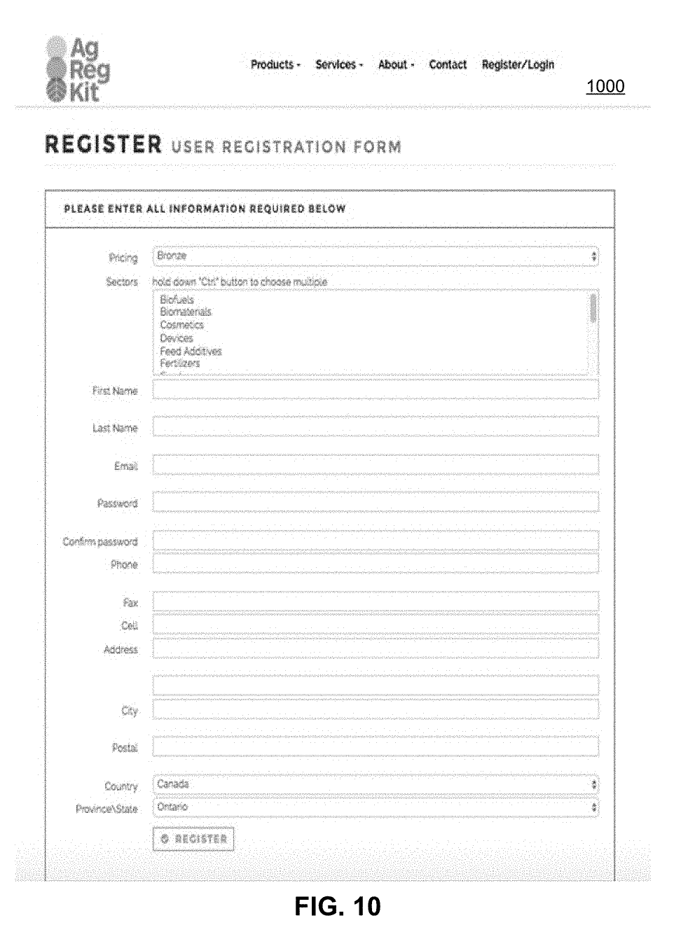

FIG. 10 illustrates a diagram of an interface 1000 for registering a user. The interface 1000 can provide a form of form fields to receive different field values. The fields' values can be used to populate a data record for particular users, where each field value can be linked to metadata or attributes. The attributes can be based on form field descriptors, for example, such as industry sector, pricing, name, address, and so on. This data may be used for queries and reports.

The above describes are example features for various embodiments.

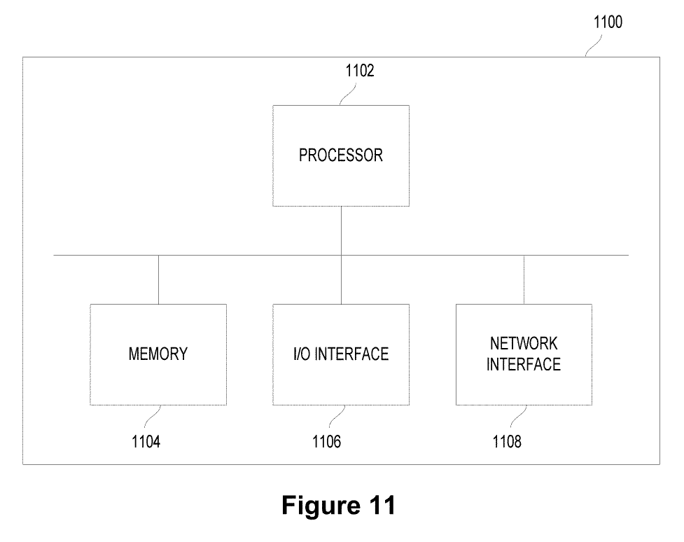

FIG. 11 illustrates, in a block diagram, an example of a computing device 1100, according to some embodiments. There is provided a schematic diagram of computing device 1100, exemplary of an embodiment. As depicted, computing device 1100 includes at least one processor 1102, memory 1104, at least one I/O interface 1106, and at least one network interface 1108. The computing device 1100 is configured as a tool for automatically generating and revising risk assessment queries, and for prompting, receiving, and processing responses to risk assessment queries in order to produce risk mitigation plan recommendations.

Each processor 1102 may be a microprocessor or microcontroller, a digital signal processing (DSP) processor, an integrated circuit, a field programmable gate array (FPGA), a reconfigurable processor, a programmable read-only memory (PROM), or any combination thereof. The processor 1102 may be optimized for analyzing text or verbal responses to queries from clients, determining the optimal next query to transmit to users based on previous responses and the totality of information required, and transmitting the optimal next question to the user.

Memory 1104 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

Each I/O interface 1106 enables computing device 1100 to interconnect with one or more input devices, such as a keyboard, mouse, camera, touch screen and a microphone, or with one or more output devices such as a display screen and a speaker. I/O interface 1106 may also include application programming interfaces (APIs) which are configured to receive data sets in the form of information signals, including verbal, communications recorded and digitized, and/or text input from users in response to queries posed to said users.

Each network interface 1108 enables computing device 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others. Network interface 1108, for example, may be used to communicate audio files (e.g., MP3, WAV, etc.) containing recorded verbal responses from a user device to the system for processing via a speech-to-text engine.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the disclosure.

As can be understood, the examples described above and illustrated are intended to be exemplary only.

1. A system to automatically identify regulatory requirements for at least one of a product and a service using at least one rule, the system comprising:
a persistent data store storing the at least one rule relating to regulatory requirements;
a processor configured to:
receive, at a user interface, input data defining at least one of a product and a service;
process the input data using the at least one rule to automatically identify at least one regulatory requirement, the at least one rule linked to at least one attribute relating to the at least one of the product and the service;
receive compliance data regarding the at least one of the product and the service;
process the compliance data by automatically evaluating the at least one regulatory requirement;
automatically generate and issue an electronic certificate of compliance for the at least one of the product and the service; and
transmit the electronic certificate.

2. The system as claimed in claim 1, wherein to process the input data, the processor is configured to generate a set of at least one regulatory requirement attribute associated with the input data.

3. The system as claimed in claim 1, wherein to process the compliance data, the processor is configured to compare the compliance data with the set of at least one regulatory requirement attribute.

4. The system as claimed in claim 3, wherein compliance is determined when there is a match between the compliance data and the at least one regulatory requirement attribute.

5. The system as claimed in claim 3, wherein noncompliance is determined when there is not a match between the compliance data and the at least one regulatory requirement attribute.

6. The system as claimed in claim 1, wherein to automatically generate and issue an electronic certificate of compliance, the processor is configured to:
upon determining compliance:
generate an electronic certificate of compliance for the at least one of the product and the service; and
electronically transmit the electronic certificate of compliance.

7. The system as claimed in claim 1, wherein to automatically generate and issue an electronic certificate of compliance, the processor is configured to:
upon determining noncompliance:
generate a message of noncompliance for the at least one of the product and the service; and
electronically transmit the message of noncompliance.

8. A system to automatically identify regulatory requirements for at least one of a product and a service using at least one rule, the system comprising:
a client server for generating and controlling a user interface to receive input data defining at least one of a product and a service, the client/server generating a regulatory compliance request based on the input data;
an application server to receive the regulatory compliance request; and
a database server to process the regulatory compliance request using rules that define applicable regulatory requirements and automatically generate an electronic certificate of compliance for the at least one of the product and the service in view of regulatory requirements;
wherein the client/server is configured to update the user interface to at least one of display and provide the electronic certificate of compliance.

9. A method of identifying applicable regulatory requirements for at least one product or service using at least one rule, the method comprising:
receiving, at a user interface, input data defining at least one product or service;
processing the input data using the at least one rule to automatically identify at least one regulatory requirement, the at least one rule linked to at least one attribute relating to the product or service;
receiving compliance data regarding the at least one product or service;
processing the compliance data by automatically evaluating the at least one applicable regulatory requirement;
automatically generating and issuing an electronic certificate of compliance for the at least one product or service; and
transmitting the electronic certificate.

10. The method as claimed in claim 9, wherein processing the input data comprises obtaining a set of at least one regulatory requirement attribute associated with the input data.

11. The method as claimed in claim 9, wherein processing the compliance data comprises comparing the compliance data with the set of at least one regulatory requirement attribute.

12. The method as claimed in claim 11, wherein compliance is determined when there is a match between the compliance data and the at least one regulatory requirement attribute.

13. The method as claimed in claim 11, wherein noncompliance is determined when there is not a match between the compliance data and the at least one regulatory requirement attribute.

14. The method as claimed in claim 9, wherein automatically generating and issuing an electronic certificate of compliance comprises:
upon determining compliance:
generating an electronic certificate of compliance for the at least one of the product and the service; and
electronically transmitting the electronic certificate of compliance.

15. The method as claimed in claim 9, wherein automatically generating and issuing an electronic certificate of compliance comprises:
upon determining noncompliance:
generating a message of noncompliance for the at least one of the product and the service; and
electronically transmitting the message of noncompliance.
